(19) United States
(12) Patent Application Publication
(10) Pub. No.: US 2011/0169824 A1
(43) Pub. Date: Jul. 14, 2011

(54) 3D IMAGE PROCESSING DEVICE AND METHOD FOR REDUCING NOISE IN 3D IMAGE PROCESSING DEVICE

(76) Inventors: Nobutoshi Fujinami, Osaka (JP); Ryuichi Shibutani, Osaka (JP); Haruko Terai, Osaka (JP); Hideki Morino, Osaka (JP)

(21) Appl. No.: 13/119,971

(22) PCT Filed: Sep. 28, 2009
(86) PCT No.: PCT/JP2009/004918

§ 371 Date: Mar. 21, 2011

(30) Foreign Application Priority Data
Sep. 29, 2008 (JP) 2008-250156

(51) Int. Cl. G06T 15/00

(52) U.S. Cl. 345/419

(57) ABSTRACT

Multiplication coefficients K1 and K2 in a first multiplying section and a second multiplying section are controlled based on the correlation in a parallax adjusted right-eye signal and a parallax adjusted left-eye signal output from a first parallax adjusting section respectively or based on the parallax calculated by the first parallax adjusting section. Thus, a 3D image processing device is provided that efficiently reduces the noise of a 3D video signal without using frame memory and without being affected by a scene change.

### TECHNICAL FIELD

The present invention relates to a 3D image processing device for reducing noise in a 3D video signal, and a noise reducing method of the 3D image processing device.

### BACKGROUND ART

As a noise reducing device targeted for random noise in 2D video, generally, a cyclic noise reducing device shown in FIG. 2 is known (Patent literature 1). The cyclic noise reducing device has frame memory, takes frame difference between an input signal level and an output signal level, and subtracts K times the frame difference from the input signal level.

In order to process a 3D video signal where two signal lines for the right eye and left eye are transmitted in parallel, however, this cyclic noise reducing device requires a noise reducing device for the right eye and a noise reducing device for the left eye. Especially, the number of frames that are required for noise reduction is estimated to increase.

This type of devices cannot always achieve accurate noise reduction in the 3D video signal. Further, the devices cannot always achieve accurate noise reduction also in a video signal that largely changes before and after the frame due to a scene change or the like because the frame difference becomes large.

In other words, when a conventional cyclic noise reducing device processes a 3D video signal, the number of frames is estimated to increase. When the frame difference increases in the scene change or the like, accurate noise reduction cannot be achieved disadvantageously.

### CITATION LIST

[Patent Literature]

[Patent Literature 1] Japanese Patent No. 3611773

### SUMMARY OF THE INVENTION

A 3D image processing device of the present invention includes the following elements:
a first input terminal for inputting a left-eye signal of a 3D video signal;
a second input terminal for inputting a right-eye signal;
a first parallax adjusting section for adjusting the parallax between the left-eye signal input from the first input terminal and the right-eye signal input from the second input terminal, and shifting the video position;
a noise reducing section for reducing noise in a parallax adjusted left-eye signal and a parallax adjusted right-eye signal that are output from the first parallax adjusting section; and
a second parallax adjusting section for receiving the parallax adjusting information output from the first parallax adjusting section, adjusting the parallax between the parallax adjusted left-eye signal and the parallax adjusted right-eye signal in which noise is reduced by the noise reducing section, and shifting the video position.
   The noise reducing section calculates a noise level based on the signal level difference between the parallax adjusted left-eye signal and the parallax adjusted right-eye signal between which parallax is eliminated by the first parallax adjusting section, and subtracts the noise level from the signal level of each of the left-eye signal and right-eye signal to reduce the noise in the 3D video signal.

Thanks to such a configuration, noise in the 3D video where two signal lines for the right eye and left eye are transmitted in parallel can be removed without using frame memory. The right-eye video signal and left-eye video signal are input with the same timing in the time axis direction, so that these signals are hardly affected by a scene change or the like. Thus, noise can be effectively reduced.

A noise reducing method of the 3D image processing device of the present invention includes the following steps:
a first parallax adjusting step of adjusting the parallax between the left-eye signal and the right-eye signal of a 3D video signal, and shifting the video position;
a noise reduction amount setting step of setting a noise reduction amount using a parallax adjusted left-eye signal and a parallax adjusted right-eye signal that are acquired in the first parallax adjusting step;
a noise reducing step of reducing noise in the parallax adjusted left-eye signal and the parallax adjusted right-eye signal based on the noise reduction amount; and
a second parallax adjusting step of receiving the parallax adjusting information acquired in the first parallax adjusting step, adjusting the parallax between the parallax adjusted left-eye signal and the parallax adjusted right-eye signal in which noise is reduced in the noise reducing step, and shifting the video position.
   In the noise reducing step, a noise level is calculated based on the signal level difference between the parallax adjusted left-eye signal and the parallax adjusted right-eye signal that are acquired in the first parallax adjusting step and have no parallax, and the noise level is subtracted from the signal level of each of the left-eye signal and right-eye signal to reduce the noise in the 3D video signal.

### BRIEF DESCRIPTION OF DRAWINGS

FIG. 1 is a block diagram of a part related to noise reduction of a 3D image processing device in accordance with an exemplary embodiment of the present invention.

FIG. 2 is a block diagram of a conventional noise reducing device.

FIG. 3 is a block diagram of a correcting section for correcting the parallax amount of the 3D image processing device in accordance with the exemplary embodiment of the present invention.

FIG. 4 is a diagram showing a target pixel and its peripheral pixels in accordance with the exemplary embodiment of the present invention.

FIG. 5 is a diagram showing a correction coefficient of the 3D image processing device in accordance with the exemplary embodiment of the present invention.

FIG. 6 is a diagram for illustrating operation of noise reduction of the 3D image processing device in accordance with the exemplary embodiment of the present invention.

FIG. 7A is a diagram showing an example of a left-eye image or right-eye image of 3D video including a projecting region in accordance with the exemplary embodiment of the present invention.

FIG. 7B is a diagram showing the relationship between the horizontal position of a screen and the projecting amount (parallax) of 3D video in accordance with the exemplary embodiment of the present invention.

FIG. 7C is a diagram showing the relationship between the horizontal position of the screen and coefficient K1 in accordance with the exemplary embodiment of the present invention.

FIG. 8 is a flow chart showing the procedure of noise reduction of the 3D image processing device in accordance with the exemplary embodiment of the present invention.

### DETAILED DESCRIPTION OF PREFERRED EMBODIMENTS

An exemplary embodiment of the present invention is described with reference to the accompanying drawings.

### Exemplary Embodiment

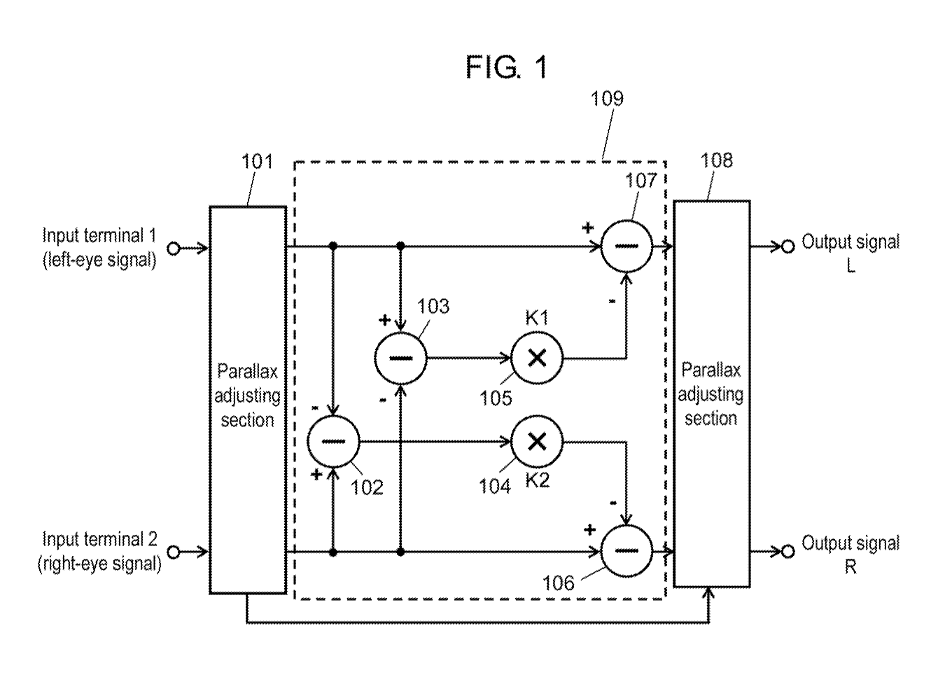

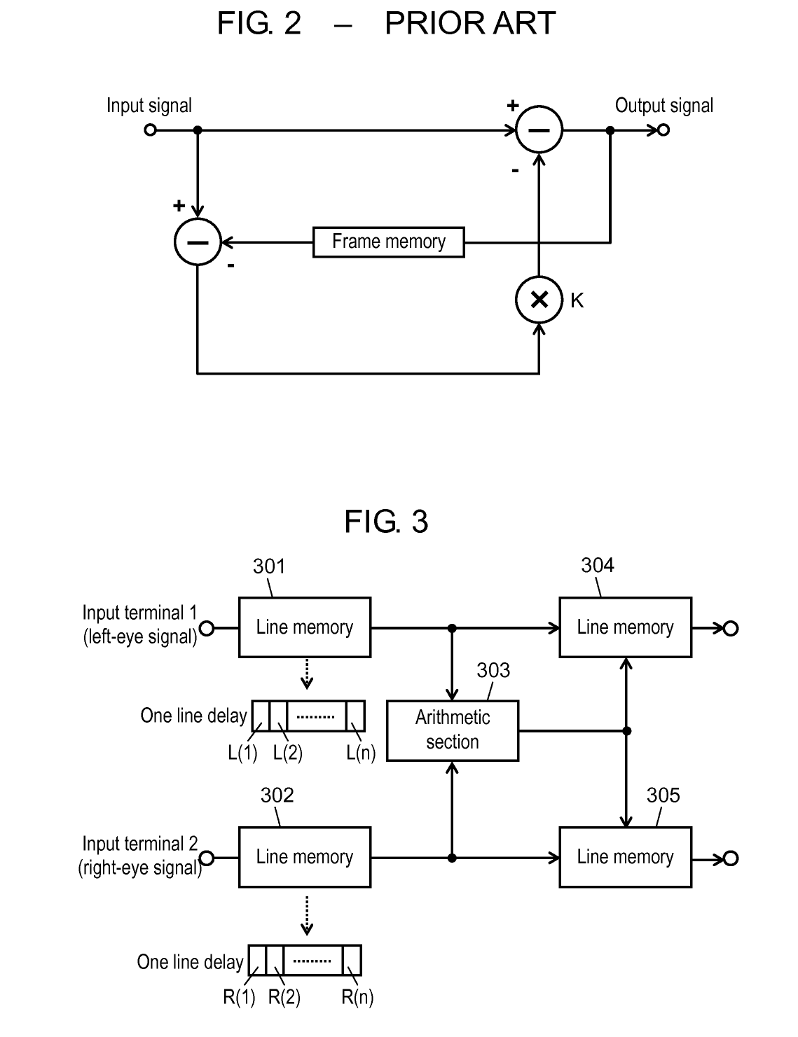

FIG. 1 is one example of a block diagram of a part related to noise reduction of a 3D image processing device in accordance with an exemplary embodiment of the present invention. This device assumes that 3D video is input as two signal lines for the left eye and right eye. The 3D image processing device of the present exemplary embodiment includes the following elements:
parallax adjusting section 101 as a first parallax adjusting section for receiving two video signals of the left-eye signal and right-eye signal from input terminal 1 as the first input terminal and input terminal 2 as the second input terminal, respectively, and adjusting the parallax between the left-eye signal and the right-eye signal;
noise reducing section 109 for receiving a parallax adjusted left-eye signal and a parallax adjusted right-eye signal that are output from parallax adjusting section 101 and adjusted in parallax, and reducing the noise; and
parallax adjusting section 108 as a second parallax adjusting section for receiving the parallax adjusted left-eye signal and the parallax adjusted right-eye signal in which noise is reduced by noise reducing section 109, and adjusting the parallax between the parallax adjusted left-eye signal and the parallax adjusted right-eye signal.
   Noise reducing section 109 includes the following elements:
subtracting sections 102 and 103 for performing subtracting processing;
multiplying sections 104 and 105 that are connected to the respective subtracting sections and multiply input signals by a predetermined coefficient;
subtracting sections 106 and 107 for receiving the signals output from parallax adjusting section 101 and the signals output from multiplying sections 104 and 105, and performing subtracting processing. Each specific configuration is described below.

First, parallax adjusting section 101 as a first parallax adjusting section is described. In order to align the video positions of a left-eye signal and a right-eye signal, parallax adjusting section 101 reduces the positional deviation between the left-eye signal and the right-eye signal due to the parallax, and makes the signal difference between the left-eye signal and the right-eye signal approach zero without limit when noise does not occur.

A specific configuration for reducing the positional deviation is described using FIG. 3. FIG. 3 is a block diagram of a correcting section for correcting the parallax amount of the 3D image processing device in accordance with the exemplary embodiment of the present invention. Signal data of the input left-eye signal is stored in line memory 301, and signal data of the input right-eye signal is stored in line memory 302. It is assumed that the stored signal data-of the left-eye signal is L(1), L(2), . . . , and L(n) from the left of the screen position, and the stored signal data of the right-eye signal is R(1), R(2), . . . , and R(n) from the right of the screen position (n shows the number of pixels on one line). In order to determine the positional deviation amount (parallax) between the left-eye signal and the right-eye signal, arithmetic section 303 calculates p that makes correlation Sp minimum in the following expression for determining correlation Sp. This p shows the positional deviation amount (parallax).

Sp=Σ|L(i)−R(i+p)|
(i=0, 1, . . . , n; p=−i, −i+1, . . . , n−i)

The parallax can be adjusted by deviating the position of the horizontal direction of the right-eye signal by p pixels with respect to the left-eye signal using line memories 304 and 305. Parallax adjusting section 101 is one example. For example, correlation Sp may be calculated using a plurality of line memories 301 and 302.

The configurations of subtracting sections 102, 103, 106, and 107 and multiplying sections 104 and 105 are described. Noise reduction is performed in the following processes:
subtracting section 102 and subtracting section 103 calculate difference between the parallax adjusted left-eye signal and the parallax adjusted right-eye signal;
multiplying section 104 and multiplying section 105 multiply the difference by coefficients (K factors) K1 and K2 calculated by a predetermined means; and
subtracting sections 106 and 107 perform subtraction.
   Here, the positions of the output signals of subtracting sections 106 and 107 are deviated from the position of the original 3D video by the processing of parallax adjusting section 101, so that the positions are returned back by parallax adjusting section 108.

Random noise occurring in an image capture system or the like is not correlated with the left-eye signal and right-eye signal, so that the noise component of the random noise can be extracted by calculation of the difference. This difference, namely the noise level, is multiplied by each of K1 and K2, and each product is subtracted from the signal level of each of the left-eye signal and right-eye signal, thereby allowing noise reduction.

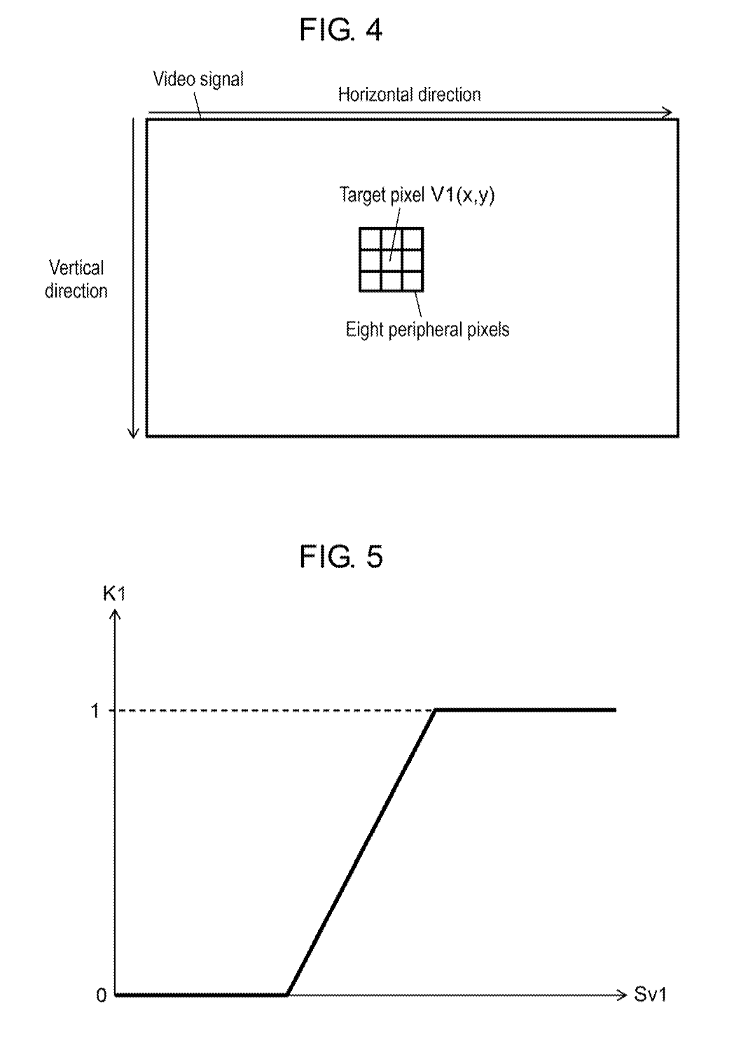

Coefficients K1 and K2 can be changed for each processing pixel, and one example of the calculating method is shown below. FIG. 4 is a diagram showing a target pixel and its peripheral pixels in accordance with the present exemplary embodiment. First, in order to calculate coefficient K1 for target pixel V1(x,y) of left-eye pixels, correlation Sv1 (as an example) of target pixel V1(x,y) with eight peripheral pixels shown in FIG. 4 is calculated using the following expression.

Sv1=Σ|V1(x,y)−V1(x+s,y+t)|
(s=1, −1 and t=1, −1)

When there is no correlation (Sv1 is large), the possibility that target pixel V1(x,y) is noise is high. Therefore, K1 is calculated using look-up table conversion shown in FIG. 5, for example. FIG. 5 is a diagram showing a correction coefficient of the 3D image processing device in accordance with the present exemplary embodiment. Similarly, K2 for right-eye pixels is calculated. Thus, by increasing the values of K1 and K2 for a pixel having a high possibility of noise, the noise can be effectively reduced.

In order to further increase the accuracy of noise reduction, in addition to the method of using the correlation in the space direction, a method of preparing a separate frame memory and using the correlation in the time direction may be employed.

Parallax adjusting section 101 processes the left-eye signal and right-eye signal in FIG. 1. However, parallax adjusting section 101 may process only the left-eye signal or may process only the right-eye signal, for example. The configuration of FIG. 1 is one example. Subtracting sections 102 and 103 may be replaced with one subtracting section, or subtracting section 107 may be replaced with an adding section.

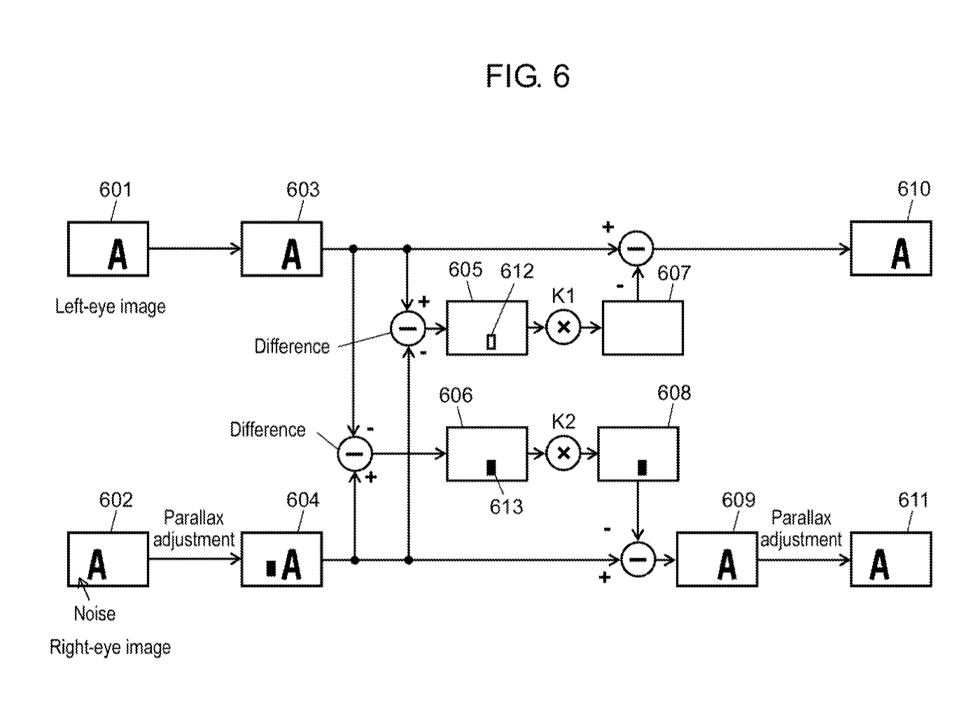

Next, noise reduction operation of the 3D image processing device of the present exemplary embodiment is described in detail using FIG. 6. When it is assumed that left-eye image 601 and right-eye image 602 including noise are input, parallax adjustment is performed by parallax adjusting section 101 of FIG. 1, and left-eye image 603 and right-eye image 604 whose positions are aligned are acquired. Differential images 605 and 606 are acquired by subtracting sections 102 and 103. Differential image 607 and differential image 608 are acquired by multiplying differential image 605 and differential image 606 by coefficient K1 and coefficient K2 determined by calculation of the correlation with the peripheral pixels and by look-up table conversion, respectively. At this time, the correlation between the pixel of left-eye image 603 at pixel position 612 and its peripheral pixels is high (Sv1 is small), so that the possibility of noise is low and the value of K1 is small. Conversely, the correlation between the pixel of right-eye image 604 at pixel position 613 and its peripheral pixels is low (Sv1 is large), so that the value of K2 is large. Therefore, differential image 607 and differential image 608 become images from which noise components are extracted, and left-eye image 610 and right-eye image 609 having reduced noise are acquired by subtracting differential image 607 and differential image 608 from left-eye image 603 and right-eye image 604. Right-eye image 609 is in a parallax adjusted state, so that it is returned to the original parallax state by parallax adjusting section 108, thereby acquiring right-eye image 611.

Next, another example of the calculating method of coefficients K1 and K2 of multiplying section 104 and multiplying section 105 is described. The calculating method of coefficient K1. is described hereinafter, and that of coefficient K2 is similar. In the calculating method of coefficient correlation Sv1 of target pixel V1(x,y) with eight peripheral pixels is calculated. When the correlation is low (Sv1 is large), the possibility that target pixel V1(x,y) is noise is determined to be high, the value of coefficient K1 can be increased, and the noise reduction amount is increased. When the correlation is not determined correctly, however, noise reducing processing can produce uncomfortable video.

When 3D video is viewed, the line of sight of a viewer is focused on a video region that projects closer to the front surface of the screen than the background, and noise becomes more conspicuous in the video region. Therefore, the noise reduction amount is increased in the projecting video region, and the noise reduction amount is decreased in the background region where noise is not so conspicuous, thereby allowing more efficient noise reduction. The projecting amount of the video can be calculated based on the parallax between the right and left eyes. In other words, in FIG. 1, the parallax between the left-eye signal input from input terminal 1 and the right-eye signal input from input terminal 2 is calculated by parallax adjusting section 101, and hence coefficient K1 is determined based on the calculated parallax. The method of calculating a parallax for each line has been described in FIG. 3. However, the projecting amount for each pixel can be estimated by calculating a parallax for each pixel. Therefore, according to the size of the parallax, the noise reduction amount, namely the value of coefficient K1 of multiplying section 105, can be controlled for each video region.

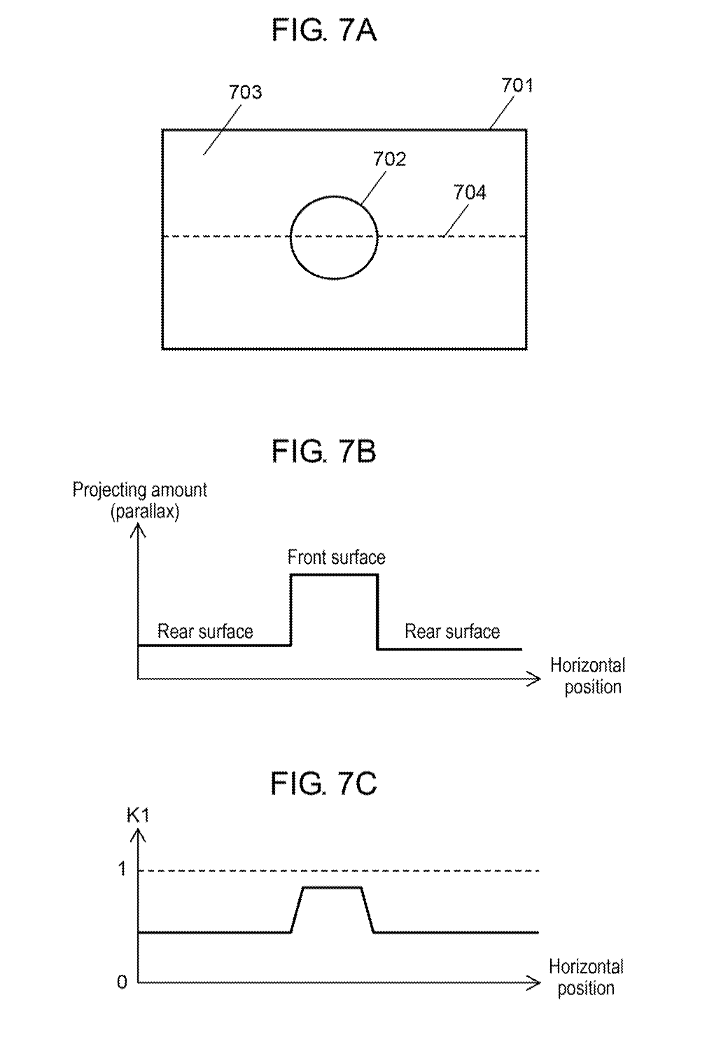

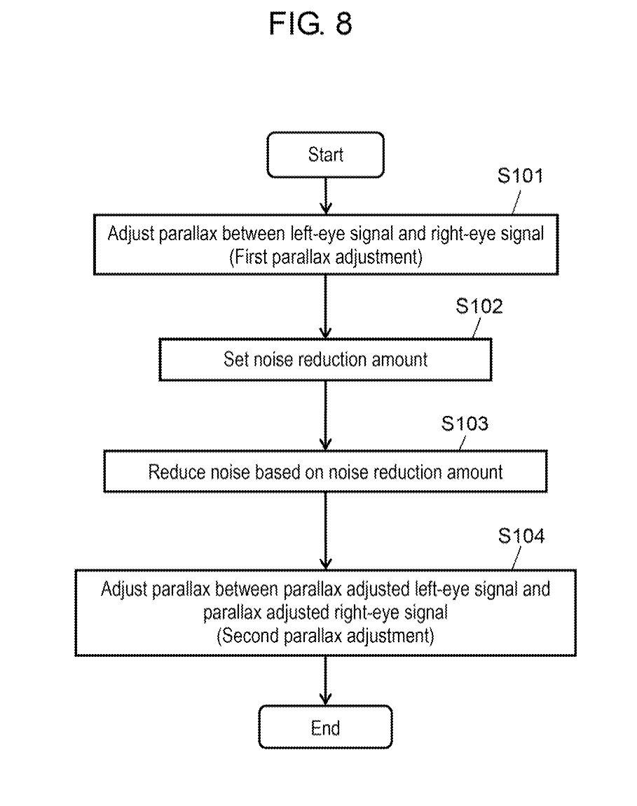

FIG. 7 is a diagram showing an example of changing the value of coefficient K1 according to the parallax in the 3D image processing device in accordance with the present exemplary embodiment. FIG. 7A is a diagram showing an example of the left-eye image or right-eye image of the 3D video including a projecting region. FIG. 7B is a diagram showing the relationship between the horizontal position of the screen and the projecting amount (parallax) of the 3D video. FIG. 7C is a diagram showing the relationship between the horizontal position of the screen and coefficient

When video region 702 of screen 701 projects in front of background region 703 in FIG. 7A, the projecting amount of video on predetermined line 703 on screen 701 varies as in FIG. 7B. Coefficient K1 is varied as in FIG. 7C. In other words, the value of K1 is increased, and the noise reduction amount is increased in video region 702 (front surface) where noise is conspicuous and the projecting amount is large. Conversely; the value of K1 is decreased, and the noise reduction amount is decreased in background region 703 where noise is inconspicuous.

Next, a noise reducing method of the 3D image processing device of the present exemplary embodiment is described. FIG. 8 is a flow chart showing the procedure of noise reduction of the 3D image processing device. In FIG. 8, parallax adjusting section 101 performs first parallax adjustment of adjusting the parallax between the left-eye signal and the right-eye signal of the 3D video signal and of shifting the video position (step S101). Then, the noise reduction amount is set using the parallax adjusted left-eye signal and the parallax adjusted right-eye signal acquired in step S101 (step S102). As discussed above, the noise reduction amount may be set in the following manner. The correlation in the space direction or time direction in the parallax adjusted left-eye signal and the parallax adjusted right-eye signal is calculated, for example. The noise reduction amount may be set to be small when the correlation is large, and the noise reduction amount may be set to be large when the correlation is small. Alternatively, the noise reduction amount may be set to be large when the parallax amount between the left-eye signal and the right-eye signal acquired in step S101, and the noise reduction amount may be set to be small when the parallax amount is small.

Next, based on the noise reduction amount acquired in step S102, the noise in the parallax adjusted left-eye signal and the parallax adjusted right-eye signal is reduced (step S103). In other words, a noise level is calculated based on the difference between the parallax adjusted left-eye signal and the parallax adjusted right-eye signal that are acquired in step S101 and have no parallax, and the noise in the 3D video signal is reduced by subtracting the noise level from the signal level of each of the left-eye signal and right-eye signal. Finally, the parallax adjusting information acquired in step S101 is received, the parallax between the parallax adjusted left-eye signal and the parallax adjusted right-eye signal where noise is reduced in step S103 is adjusted, the video position is shifted, and a left-eye signal and right-eye signal having the original parallax are acquired (step S104).

As discussed above, in the present embodiment, the correlation of a target pixel with its peripheral pixels is calculated, it is determined whether the target pixel is noise, and the noise reduction amount is controlled. In addition, the noise reduction amount is controlled also according to the projecting amount (parallax) of the video region. Thus, the noise reduction effect of the 3D image processing device can be enhanced.

### INDUSTRIAL APPLICABILITY

The present invention provides a 3D image processing device for reducing noise in a 3D video signal, and is useful for noise removal in 3D video where two signal lines for the left eye and right, eye are transmitted in parallel.

### REFERENCE MARKS IN THE DRAWINGS

1 first input terminal
2 second input terminal
101 parallax adjusting section (first parallax adjusting section)
102 subtracting section (third subtracting section)
103 subtracting section (first subtracting section)
104 multiplying section (second multiplying section)
105 multiplying section (first multiplying section)
106 subtracting section (fourth subtracting section)
107 subtracting section (second subtracting section)
108 parallax adjusting section (second parallax adjusting section)
109 noise reducing section
301, 302, 304, 305 line memory
303 arithmetic section
601, 603, 610 left-eye image
602, 604, 609, 611 right-eye image
605, 606, 607, 608 differential image
612, 613 pixel position
701 screen
702 video region
703 background region
704 line

1. A 3D image processing device comprising:
a first input terminal for inputting a left-eye signal of a 3D video signal;
a second input terminal for inputting a right-eye signal;
a first parallax adjusting section for adjusting parallax between the left-eye signal input from the first input terminal and the right-eye signal input from the second input terminal, and shifting a video position;
a noise reducing section for reducing noise in a parallax adjusted left-eye signal and a parallax adjusted right-eye signal that are output from the first parallax adjusting section; and
a second parallax adjusting section for receiving parallax adjusting information output from the first parallax adjusting section, adjusting parallax between the parallax adjusted left-eye signal and the parallax adjusted right-eye signal in which noise is reduced by the noise reducing section, and shifting a video position,
wherein the noise reducing section calculates a noise level based on difference between signal levels of the parallax adjusted left-eye signal and the parallax adjusted right-eye signal where parallax is eliminated by the first parallax adjusting section, and subtracts the noise level from the signal level of each of the left-eye signal and the right-eye signal to reduce noise in the 3D video signal.

2. The 3D image processing device of claim 1, wherein
the noise reducing section calculates correlation in a space direction or time direction in the parallax adjusted left-eye signal and the parallax adjusted right-eye signal, reduces a noise reduction amount when the correlation is large, and increases the noise reduction amount when the correlation is small.

3. The 3D image processing device of claim 1, wherein
the noise reducing section increases a noise reduction amount when a parallax amount between the left-eye signal and the right-eye signal is large, and decreases the noise reduction amount when the parallax amount is small, the parallax amount being calculated by the first parallax adjusting section.

4. A 3D image processing device of claim 1, wherein
the noise reducing section comprises:
a first subtracting section for subtracting a signal level of a parallax adjusted right-eye signal output from the first parallax adjusting section from a signal level of a parallax adjusted left-eye signal output from the first parallax adjusting section;
a first multiplying section for multiplying a first subtraction signal output from the first subtracting section by a first coefficient;
a second subtracting section for subtracting a signal level of a first multiplication signal output from the first multiplying section from the signal level of the parallax adjusted left-eye signal;
a third subtracting section for subtracting the signal level of the parallax adjusted left-eye signal from the signal level of the parallax adjusted right-eye signal;
a second multiplying section for multiplying a second subtraction signal output from the third subtracting section by a second coefficient; and
a fourth subtracting section for subtracting a signal level of a second multiplication signal output from the second multiplying section from the signal level of the parallax adjusted right-eye signal, and
the second parallax adjusting section receives an output of the second subtracting section and an output of the fourth subtracting section.

5. The 3D image processing device of claim 4, wherein
multiplication coefficients in the first multiplying section and the second multiplying section, respectively, are set to small values when correlation in a space direction or a time direction in the parallax adjusted left-eye signal and the parallax adjusted right-eye signal is large, and are set to large values when the correlation is small.

6. The 3D image processing device of claim 4, wherein
multiplication coefficients in the first multiplying section and the second multiplying section are set to large values when a parallax amount between the left-eye signal and the right-eye signal is large, and are set to small values when the parallax amount is small, the parallax amount being calculated by the first parallax adjusting section.

7. A noise reducing method of a 3D image processing device comprising:
a first parallax adjusting step of adjusting parallax between a left-eye signal and a right-eye signal of a 3D video signal, and shifting a video position;
a noise reduction amount setting step of setting a noise reduction amount using a parallax adjusted left-eye signal and a parallax adjusted right-eye signal that are acquired in the first parallax adjusting step;
a noise reducing step of reducing noise in the parallax adjusted left-eye signal and the parallax adjusted right-eye signal based on the noise reduction amount; and
a second parallax adjusting step of receiving parallax adjusting information acquired in the first parallax adjusting step, adjusting parallax between the parallax adjusted left-eye signal and the parallax adjusted right-eye signal in which noise is reduced in the noise reducing step, and shifting a video position,
wherein in the noise reducing step, a noise level is calculated based on difference between signal levels of the parallax adjusted left-eye signal and the parallax adjusted right-eye signal that are acquired in the first parallax adjusting step, and the noise level is subtracted from the signal level of each of the left-eye signal and right-eye signal to reduce noise in a 3D video signal.

8. The noise reducing method of the 3D image processing device of claim 7, wherein
in the noise reduction amount setting step, correlation in a space direction or a time direction in the parallax adjusted left-eye signal and the parallax adjusted right-eye signal is calculated, a noise reduction amount is set to be small when the correlation is large, and the noise reduction amount is set to be large when the correlation is small.

9. The noise reducing method of the 3D image processing device of claim 7, wherein
in the noise reduction amount setting step, a noise reduction amount is set to be large when a parallax amount between the left-eye signal and the right-eye signal is large, and the noise reduction amount is set to be small when the parallax amount is small, the parallax amount being acquired in the first parallax adjusting step.
